(19) United States
(12) Patent Application Publication
(10) Pub. No.: US 2025/0018863 A1
(43) Pub. Date: Jan. 16, 2025

(54) Actuator Buffer Structure, Rearview Mirror and Vehicle

(71) Applicant: Ningbo SMR Huaxiang Automotive Mirrors Ltd., Zhejiang Province (CN)

(72) Inventors: Liang ZHANG, Zhejiang Province (CN); Zhanglong PENG, Zhejiang Province (CN)

(21) Appl. No.: 18/754,392

(22) Filed: Jun. 26, 2024

(30) Foreign Application Priority Data
Jul. 10, 2023 (CN) 202310843211.0

(51) Int. Cl. B60R 1/072

(52) U.S. Cl. CPC B60R 1/072

(57) ABSTRACT

The present disclosure discloses an actuator buffer structure, rearview mirror and vehicle; the actuator buffer structure comprising a base frame for installing a rear view element and an actuator fixedly set and rotatably connected to the base frame; the output shaft of the actuator is connected to the base frame via a clutch assembly; when the actuator is started, the output shaft is capable of driving the base frame, together with the rear view element, to rotate around the axis by means of the clutch assembly; when the base frame, together with the rear view element, is driven to rotate by external force, the actuator, together with its self-locking output shaft, remains stationary through the clutch assembly. By connecting the output shaft of the actuator to the base frame via the clutch assembly, damage to the actuator due to relative rotation between the output shaft and the actuator can be avoided by separating the clutch assembly during manual adjustment of the rear view element angle, thus effectively improving the service life of the actuator and even the vehicle.

### CROSS-REFERENCE TO RELATED APPLICATION

This application claims priority from Chinese Patent Application No. CN 202310843211.0, filed on Jul. 10, 2023, the entity of which is incorporated herein by reference.

### TECHNICAL FIELD

The present disclosure relates to the field of automotive technology, specifically to an actuator buffer structure, rearview mirror, and vehicle.

### BACKGROUND

The rearview mirror presents different rear view when different drivers drive the vehicle. At this time, the mirror surface needs to be adjusted to meet the driving needs of different drivers. There are two ways to adjust the mirror surface of the rearview mirror: front and rear folding and up and down adjustment.

The way to adjust the mirror surface is divided into electric and manual adjustment in the prior art. At this stage, the durability of electric adjustment is relatively good. There is gear damage in the manual adjustment process, so solving the durability of manual adjustment is an important link to improve the quality of the rearview mirror.

### SUMMARY

One objective of the present disclosure is to provide a buffer structure that can prevent damage to the actuator during manual adjustment.

Another objective of the present disclosure is to provide a rearview mirror with good product quality.

Another objective of the present disclosure is to provide a vehicle with good product quality.

In order to achieve the above objective, the technical solution adopted by the present disclosure is as follows: an actuator buffer structure, which includes a base frame for installing the rear view element and an actuator fixedly set and rotatably connected to the base frame; the output shaft of the actuator is connected to the base frame through a clutch assembly; when the actuator is started, the output shaft is able to drive the base frame together with the rear view element to rotate around the axis through the clutch assembly; when the base frame and the rear view element are rotated along the actuator by external force, the output shaft is disengaged from the base through the clutch assembly and remains stationary with the actuator.

Preferably, the clutch assembly includes a adjusting buffer block and a spring; the adjusting buffer block is axially slidably installed on the output shaft through a guiding structure, and the adjusting buffer block is adapted to be elastomically connected to the actuator or the base frame through the spring; the adjusting buffer block is linked with the base frame through a clutch structure; when the actuator is started, the adjusting buffer block maintains engagement with the base frame in the circumferential direction through the clutch structure under the action of elasticity; when the base frame is driven by external force, the adjusting buffer block disengages from the engagement with the base frame in the circumferential direction through the clutch structure.

Preferably, the adjusting buffer block is slidably matched with the output shaft through a through-hole; the guiding structure includes a guiding groove that is axially extended along the output shaft on the side, and a guiding block that is set on the side wall of the through-hole; the guiding block is slidably matched with the guiding groove along the axis and simultaneously limitedly matched with it along the circumferential direction.

Preferably, the adjusting buffer block forms the clutch structure by frictional engagement with the base frame in the circumferential direction through the end face. When the actuator is started, the driving force of the actuator is less than the frictional force between the end face of the adjusting buffer block and the base frame in the circumferential direction. When the base frame is driven by external force, the pressing force received by the base frame is greater than the frictional force but less than the self-locking force of the output shaft.

Preferably, the clutch structure comprises a clutch groove set on the end face of the adjusting buffer block and a clutch block set on the base frame; the clutch groove and the clutch block engage with each other along the circumferential direction via an inclined plane; when the actuator is started, the driving force of the actuator is less than the engaging force of the clutch groove and the clutch block along the circumferential direction; when the base frame is driven by external force, the pressing force on the base frame is greater than the engaging force but less than the self-locking force of the output shaft.

Preferably, the clutch assembly further comprises a base frame buffer block, which can be detachably installed on the base frame. The base frame buffer block is adapted to axially slide with the adjusting buffer block through a through hole disposed at the center thereof, and through matched with the positioning sleeve. The clutch block is disposed on the end face of the base frame buffer block, forming the clutch structure between the adjusting buffer block and the base frame buffer block.

Preferably, the base frame includes a first installation area and a second installation area that are interconnected. The actuator is installed in the first installation area and the output shaft extends to the second installation area. The clutch assembly is installed in the second installation area, and the base frame buffer block is matched with the second installation area by means of a positioning structure.

Preferably, the clutch assembly is first installed on the output shaft, and then the actuator, together with the clutch assembly, is installed on the base frame. The base frame buffer block is connected to the side wall of the second installation area through fasteners at the center. The positioning structure includes at least one horizontal limiting surface set on the side of the base frame buffer block and at least one horizontal positioning surface set on the side of the second installation area. The base frame buffer block is adapted to fit against the positioning surface through the limiting surface.

Preferably, the end of the second installation area is provided with an installation sleeve penetrating the base frame, and the axis of the output shaft is aligned with the axis of the installation sleeve; the actuator is first installed on the base frame, and then the clutch assembly is installed along the installation sleeve on the output shaft, and the base frame buffer block is fixed on the outside of the installation sleeve by a pair of symmetrically arranged fasteners; the positioning structure includes a pair of positioning columns spaced apart and set on the outer end side of the installation sleeve, and a pair of positioning hole spaced apart and set on the side of the base frame buffer block; the base frame buffer block is adapted to be positioned and matched with the positioning columns through the positioning hole.

A rearview mirror, comprising the above actuator buffer structure.

A vehicle, comprising the above rearview mirror.

Compared with the prior art, the present disclosure has the beneficial effects below:

By connecting the output shaft of the actuator to the base frame through the clutch assembly, damage to the actuator caused by relative rotation between the output shaft of the actuator and the actuator can be avoided by separating the clutch assembly during manual adjustment of the rear view element angle; thereby effectively improving the service life of the actuator.

### BRIEF DESCRIPTION OF THE DRAWINGS

FIG. 1 is a schematic diagram of the internal local structure of the rearview mirror of the present disclosure.

FIG. 2 is a schematic diagram of the separation state of the actuator and clutch assembly of the present disclosure.

FIG. 3 is a schematic diagram of the structure of the actuator of the present disclosure.

FIG. 4 is a schematic diagram of the structure of the adjusting buffer block in one embodiment of the present disclosure.

FIG. 5 is a schematic diagram of the structure of the adjusting buffer block in another embodiment of the present disclosure.

FIG. 6 is the second schematic diagram of the structure of the adjusting buffer block in another embodiment of the present disclosure.

FIG. 7 is a schematic diagram of the structure of one embodiment of the base frame buffer block of the present disclosure.

FIG. 8 is a schematic diagram of the other embodiment of the base frame buffer block of the present disclosure.

FIG. 9 is a schematic diagram of another embodiment of the base frame buffer block of the present disclosure.

FIG. 10 is a schematic diagram of the structure of one embodiment of the base frame of the present disclosure.

FIG. 11 is a schematic diagram of the clutch assembly including the base frame buffer block shown in FIG. 7 installed on the base frame shown in FIG. 10 of the present disclosure.

FIG. 12 is a schematic diagram of the clutch assembly including the base frame buffer block shown in FIG. 8 installed on the base frame shown in FIG. 9 of the present disclosure.

FIG. 13 is a schematic diagram of another embodiment of the base frame structure of the present disclosure.

FIG. 14 is a schematic diagram of the clutch assembly including the base frame buffer block shown in FIG. 9 installed on the base frame shown in FIG. 13 of the present disclosure.

In the drawings: base frame 100, first installation area 110, second installation area 120, positioning block 121, installation sleeve 122, positioning column 123, first installation hole 124, actuator 200, installation section 210, output shaft 220, guiding groove 221, clutch assembly 3, spring 31, adjusting buffer block 32, through hole 320, clutch groove 321, extension 322, guiding block 3220, base frame buffer block 33, second installation hole 330, clutch block 331, limiting surface 332, positioning sleeve 333, cover plate 334, positioning hole 3340.

### DETAILED DESCRIPTION OF THE EMBODIMENTS

The present disclosure is further described below in combination with specific implementations. It should be noted that the various embodiments or technical features described below can be arbitrarily combined to form new embodiments without conflicts.

In the description of the present disclosure, it should be noted that for orientation terms, orientations or positional relationships indicated by the terms “center”, “transverse”, “longitudinal”, “length” “width”, “thickness”, “upper”, “lower”, “front”, “rear”, “left”, “right”, “vertical”, “horizontal”, “top”, “bottom”, “inside”, “outside”, “clockwise”, “anticlockwise”, and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms cannot construed as limiting the specific protection scope of the present disclosure.

It should be noted that the terms “first”, “second”, etc. in the specification and claims of the present disclosure are used to distinguish similar objects, and do not have to be used to describe a specific order or sequence.

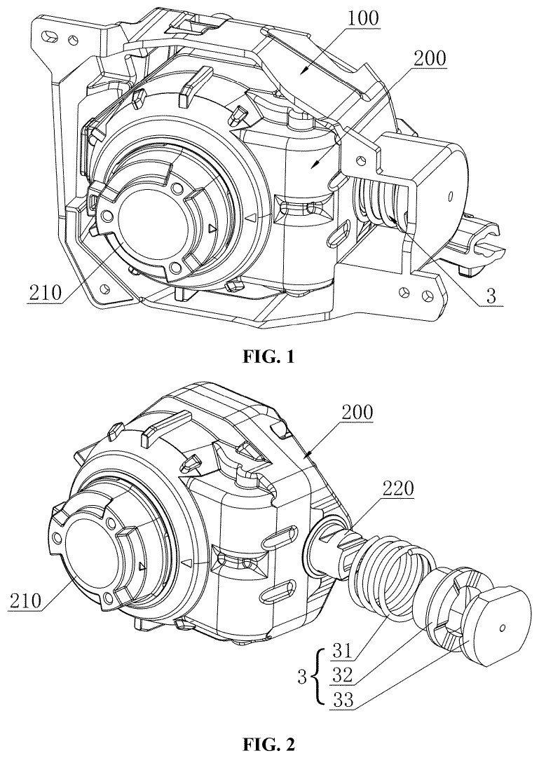

One aspect of the present disclosure provides an actuator buffer structure, as shown in FIG. 1 to FIG. 14. One preferred embodiment includes a base frame 100 for installing rear view element and an actuator 200 fixedly positioned and rotatably coupled to the base frame 100. The actuator 200 can drive the base frame 100 through the output shaft 220 to rotate the rear view element about the axis of the output shaft 220 to achieve angular adjustment of the rear view element. There is also a clutch assembly 3, which connects the output shaft 220 of the actuator 200 to the base frame 100 through the clutch assembly 3.

When the user adjusts the angle of the rear view element electrically, the actuator 200 is started. At this time, the clutch assembly 3 can maintain engagement, so that the actuator 200 can drive the rear view element to deflect in a similar way as traditional methods, that is, the output shaft 220 of the actuator 200 is connected to the base frame 100 in the circumferential direction through the clutch assembly 3. Then, after the actuator 200 is started, it can drive the base frame 100 and the rear view element to rotate by driving the rotation of the output shaft 220.

When the user manually adjusts the angle of the rear view element, the actuator 200 is in a stopped state, and at this time, the base frame 100 can separate the clutch assembly 3 under manual drive to separate the actuator 200 together with the self-locking output shaft 220 from the base frame 100 and keep them stationary. Then, the base frame 100 can drive the rear view element to rotate around the axis of the output shaft 220 under manual drive. Compared to the traditional manual adjustment method, during the rotation of the rear view element, the actuator 200 and the output shaft 220 always remain relatively stationary, that is, there is no relative rotation between the two, thereby avoiding damage to the actuator 200 caused by the relative rotation of the output shaft 220 with respect to the actuator 200, and effectively improving the service life of the actuator 200.

It should be noted that, as shown in FIG. 1 to FIG. 3, one side of the actuator 200 is provided with an installation section 210, and the actuator 200 can be installed on the car body through the installation section 210. The axial extension direction of the installation section 210 is perpendicular to the axis of the output shaft 220; when the base frame 100 rotates in cooperation with the actuator 200, the axis of rotation of the base frame 100 can coincide with the axis of the output shaft 220.

It would be understood that the specific structure and working principle of the actuator 200 and rear view element are well-known to those skilled in the art, and commonly used actuators 200 can use motors, etc. The rear view element can be a mirror and/or camera.

In the traditional method of adjusting the angle of the rear view element, to achieve the angle adjustment of the rear view element through the actuator 200, it is necessary to rotate the base frame 100 and the actuator 200 during installation, and fix the output shaft 220 of the actuator 200 to the base frame 100. Then, when the actuator 200 drives the output shaft 220 to rotate, the output shaft 220 can drive the base frame 100 and the installed rear view element to rotate together. Since the stability of the rear view element needs to be ensured during use, generally, after the actuator 200 stops, the actuator 200 can grip the output shaft 220 through a brake structure, to keep the base frame 100 stable based on the brake of the output shaft 220 when the actuator 200 stops. Therefore, when manually pressing the base frame 100 to adjust the angle of the rear view element, the driving force exerted on the base frame 100 by the output shaft 220 of the actuator 200 will forcibly disengage the brake and rotate around the actuator 200. This can easily cause damage to the brake structure of the actuator 200, and may cause the actuator 200 to malfunction and fail to maintain stability.

Therefore, in this disclosure, a clutch assembly 3 is installed between the output shaft 220 of the actuator 200 and the base frame 100. When electrically adjusting the angle of the rear view element, the clutch assembly 3 is in the engaged state, that is, the output shaft 220 of the actuator 200 and the base frame 100 are stably connected through the clutch assembly 3, so that the actuator 200 can stably drive the output shaft 220 to rotate the rear view element. When manually adjusting the angle of the rear view element, the clutch assembly 3 can separate the output shaft 220 and the base frame 100, so that the actuator 200 and the output shaft 220 form a whole through the self-locking structure of the holding brake, and under the manual driving force, the actuator 200 and the output shaft 220 form the whole can remain stationary, so that the base frame 100 can drive the rear view element to rotate around the axis of the output shaft 220 together, compared with the traditional installation method, which can effectively avoid relative rotation between the actuator 200 and the output shaft 220.

One embodiment of the present disclosure, as shown in FIG. 2 to FIG. 14, the clutch assembly 3 comprises a adjusting buffer block 32 and a spring 31. The adjusting buffer block 32 can be axially slidably installed on the output shaft 220 through a guiding structure. That is, the adjusting buffer block 32 can only move axially relative to the output shaft 220 under the guidance of the guiding structure. At the same time, the adjusting buffer block 32 can be matched with the base frame 100 through a clutch structure. The adjusting buffer block 32 can also be elastically connected to the actuator 200 or the base frame 100 through the spring 31, and the spring 31 can apply the necessary engagement force to the clutch structure through spring force. Thus, when adjusting the rear view element electrically, the adjusting buffer block 32 can be kept engaged with the base frame 100 under the action of the spring force of the spring 31 through the clutch structure, and then the output shaft 220 can drive the base frame 100 to rotate synchronously under the engagement force of the clutch structure, so that the base frame 100 drives the rear view element to deflect around the axis of the output shaft 220 to achieve angle adjustment. When adjusting the rear view element manually, the pressure applied manually will be greater than the engagement force applied to the clutch structure by the spring 31, causing the clutch structure to disengage and separate, and then the adjusting buffer block 32 can remain stationary through the clutch structure, while the base frame 100 rotates relative to the adjusting buffer block 32. Since the adjusting buffer block 32 can only move axially relative to the output shaft 220, the output shaft 220 will also remain stationary with the adjusting buffer block 32, that is, the actuator 200, the output shaft 220 and the adjusting buffer block 32 will remain stationary synchronously, to ensure that there is no relative motion between the actuator 200 and the output shaft 220, thereby avoiding damage to the actuator 200 and the output shaft 220 due to relative rotation.

It can be understood that the spring 31 can apply a biting force to the clutch structure by being opposed to the actuator 200 and the adjusting buffer block 32 at both ends, thus using the elastic force generated by the compression of the spring 31. Of course, the adjusting buffer block 32 can also be matched by being opposed to the base frame 100 through the spring 31 near the end close to the actuator 200, or the adjusting buffer block 32 can also be matched by being opposed to the base frame 100 through the spring 31 away from the end far from the actuator 200, and thereby applying a engagement force to the clutch structure through the elastic force generated by the compression or stretching of the spring 31.

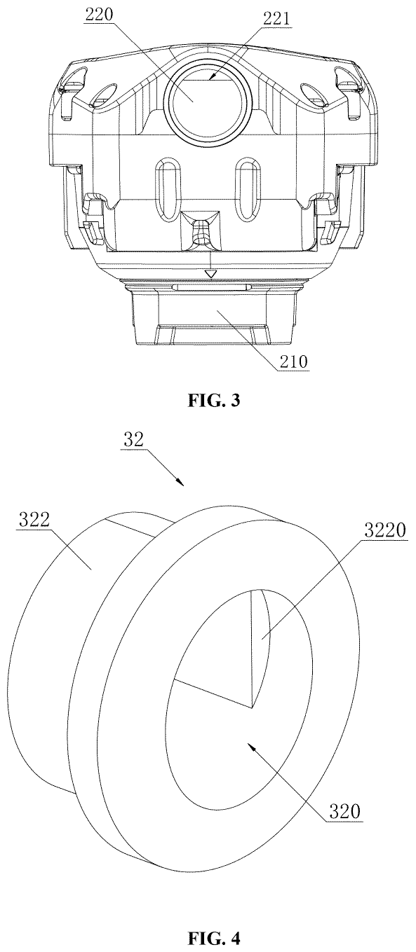

In this embodiment, as shown in FIG. 3 to FIG. 6, the adjusting buffer block 32 slides and fits with the output shaft 220 through the through hole 320. The guiding structure includes a guiding groove 221 extending axially along the side of the output shaft 220, and a guiding block 3220 set on the side wall of the through hole 320. The guiding block 3220 slides and fits with the guiding groove 221 axially, and is also limitedly fitted along the circumferential direction.

It can be understood that the guide groove 221 can also be set on the side of the through hole 320, and the guide block 3220 is correspondingly set on the side of the output shaft 220. Moreover, the number of guide grooves 221 and guide blocks 3220 can be one-to-one corresponding or multiple depending on the specific structure or actual needs of the guide groove 221 and guide block 3220, and the specific number can be chosen by those skilled in the art. For the convenience of describing the content later, in this embodiment, the guide groove 221 is preferably set on the side of the output shaft 220, and the guide block 3220 is set on the side of the through hole 320.

Specifically, there are various specific structures of the guide groove 221 and the guide block 3220, including but not limited to the following two types.

Structure 1: As shown in FIG. 3 to FIG. 6, a plane is machined along the axis on the side of the output shaft 220 by processes such as cutting and grinding, and the plane can form the required guiding groove 221 relative to the output shaft 220. At the same time, while machining the through hole 320, a plane extending along the axis can be left on the side of the through hole 320, and the plane can form the required guiding block 3220 relative to the through hole 320. Therefore, when installing the adjusting buffer block 32, the adjusting buffer block 32 can be inserted over the output shaft 220 through the through hole 320, and then the side plane of the output shaft 220 can match with the side plane of the through hole 320 to make the adjusting buffer block 32 only axially movable relative to the output shaft 220.

It can be understood that the planes forming the guide groove 221 and the guide block 3220 can be horizontal planes, arc-shaped planes, or other shaped planes, as long as the adjusting buffer block 32 and the output shaft 220 cannot rotate relative to each other in the circumferential direction.

Structure 2: The guiding groove 221 can be a spline groove set on the side of the output shaft 220, and the guiding block 3220 can be a spline set on the inner side of the through hole 320. Thus, the adjusting buffer block 32 can be spline-connected to the output shaft 220.

One embodiment of this disclosure, as shown in FIG. 4, the end face of the adjusting buffer block 32 is flat, and the adjusting buffer block 32 can form a clutch structure with the base frame 100 through frictional engagement with the end face. When the adjusting buffer block 32 is installed, the adjusting buffer block 32 can be pressed against the inner wall of the base frame 100 in the axial direction opposite to the end face under the spring force of the spring 31. At this time, the spring force of the spring 31 on the adjusting buffer block 32 can be converted into positive pressure between the end face of the adjusting buffer block 32 and the base frame 100. Then, the adjusting buffer block 32 is engaged with the inner wall of the base frame 100 in the circumferential direction through the frictional force formed by the positive pressure.

Thus, when adjusting the angle of the electrically adjustable rear view element, the driving force of the actuator 200 needs to be smaller than the frictional force between the end face of the adjusting buffer block 32 and the inner wall of the base frame 100 along the circumferential direction, to ensure that the output shaft 220 and the base frame 100 are in frictional engagement for synchronous movement. Thereby, the actuator 200 can drive the rear view element to rotate with the rotation of the output shaft 220 to achieve angle adjustment. When adjusting the angle of the rear view element manually, the pressing force manually applied to the base frame 100 needs to be greater than the frictional force between the end face of the adjusting buffer block 32 and the inner wall of the base frame 100 along the circumferential direction, and the pressing force applied to the base frame 100 also needs to be smaller than the self-locking force between the output shaft 220 and the actuator 200, to ensure that the base frame 100 can drive the rear view element to rotate while the output shaft 220 can remain relatively stationary with the actuator 200.

In this embodiment, as shown in FIG. 4, a positioning sleeve 333 is also set on the side wall of the base frame 100 that corresponds to the adjusting buffer block 32. Thus, the adjusting buffer block 32 can be positioned and matched with the positioning sleeve 333 through the through hole 320 in the middle to ensure the structural stability when the adjusting buffer block 32 is friction matched with the base frame 100.

In this embodiment, as shown in FIG. 4, FIG. 7, FIG. 10, and FIG. 11, the clutch assembly 3 further includes a base frame buffer block 33. The base frame buffer block 33 can be detachably installed at the corresponding position of the base frame 100 through fasteners. The positioning sleeve 333 is located in the middle of the end face of the adjusting buffer block 32 directly opposite the base frame buffer block 33. Thus, during the installation of clutch assembly 3, the base frame buffer block 33 can be supported and matched with the adjusting buffer block 32 through the positioning sleeve 333; Moreover, under the elastic force of spring 31, the adjusting buffer block 32 can achieve a friction match between the end face and the end face of base frame buffer block 33, thereby forming the required clutch structure.

It can be understood that due to the thin thickness of the base frame 100 and the friction performance not necessarily meeting the needs of the clutch structure; Therefore, by installing an additional base frame buffer block 33 for friction match with the adjusting buffer block 32, and setting the performance of the base frame buffer block 33, it can be ensured that the match between the base frame buffer block 33 and the adjusting buffer block 32 meets the needs of the clutch structure.

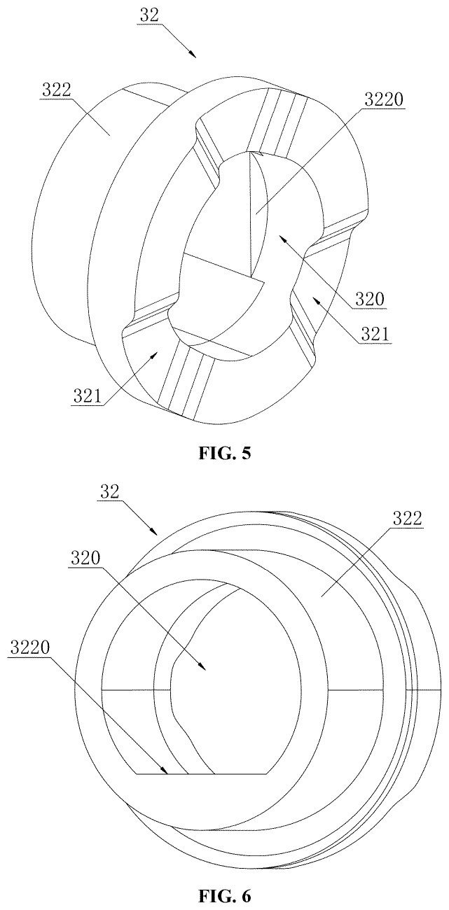

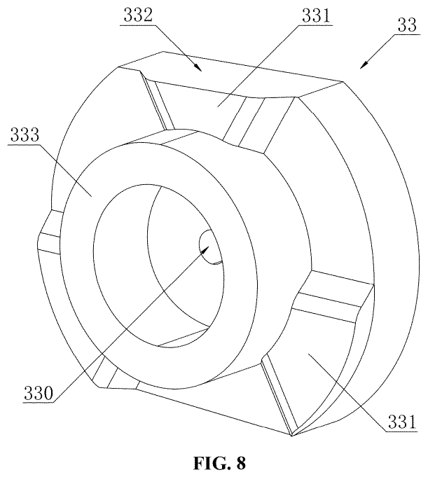

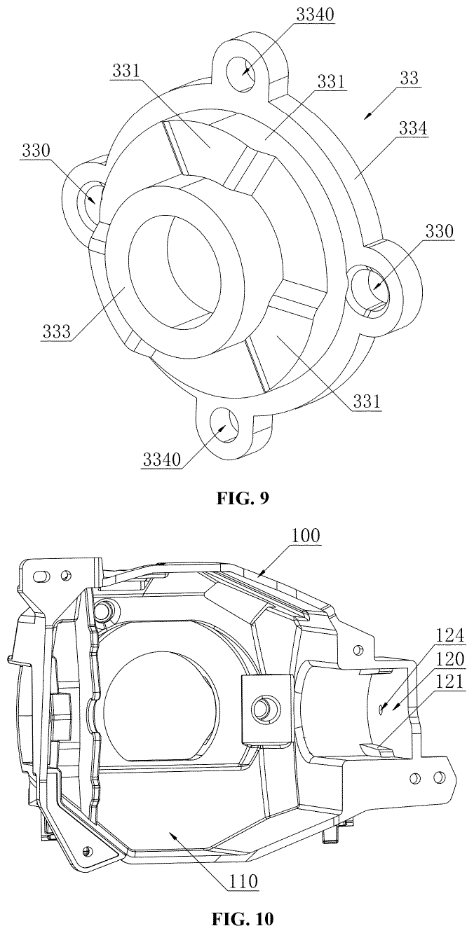

Another embodiment of the present disclosure, as shown in FIG. 5, FIG. 8, FIG. 9 to FIG. 12, the clutch structure includes a clutch groove 321 set on the end face of the adjusting buffer block 32 and a clutch block 331 set on the base frame 100. When installing the adjusting buffer block 32, the adjusting buffer block 32 can be axially engaged with the end face of the clutch block 331 through the end face of the clutch groove 321 under the spring force of the spring 31, so that the clutch groove 321 and the clutch block 331 can be engaged along the circumferential direction through the inclined surface under the action of the spring force.

Therefore, when adjusting the angle of the electrically adjustable rear view element, the driving force of the actuator 200 needs to be less than the engagement force of the clutch groove 321 and the clutch block 331 along the circumferential direction, so as to ensure that the output shaft 220 and the base frame 100 maintain synchronous movement through the engagement of the clutch groove 321 and the clutch block 331, and then the actuator 200 can drive the rear view element to rotate with the output shaft 220 to achieve angle adjustment. When manually adjusting the angle of the rear view element, the pressing force applied to the base frame 100 needs to be greater than the engagement force of the clutch groove 321 and the clutch block 331, and at the same time, the pressing force applied to the base frame 100 needs to be less than the self-locking force of the output shaft 220 and the actuator 200.

It is understood that the positions of the clutch groove 321 and the clutch block 331 can be interchanged, that is, the clutch groove 321 is set on the base frame 100 and the clutch block 331 is set on the adjusting buffer block 32. For the convenience of describing the subsequent content, the preferred embodiment in this embodiment is to set the clutch groove 321 on the adjusting buffer block 32 and the clutch block 331 on the base frame 100.

The specific shape of the clutch groove 321 and the clutch block 331 is not specifically limited here, as long as the stable engagement between the clutch groove 321 and the clutch block 331 can be achieved through an inclined surface in the circumferential direction. Moreover, the inclined surface of the clutch groove 321 and the clutch block 331 in the circumferential direction can be an arc surface, a flat surface, or other shaped surface, as long as the above requirements of the clutch structure are met.

At the same time, the specific number of settings for the clutch groove 321 and the clutch block 331 can be selected by those skilled in the art according to actual needs. It can be one corresponding unit or multiple corresponding units.

In this embodiment, as shown in FIG. 5, FIG. 8, and FIG. 9, the base frame 100 is provided with a side wall of the clutch block 331 and a positioning sleeve 333. The clutch block 331 is located on the side of the positioning sleeve 333. Thus, the adjusting buffer block 32 can be positioned and matched with the positioning sleeve 333 through the through hole 320, ensuring the stability of the mating structure of the clutch groove 321 and the clutch block 331.

It should be understood that during the installation of the clutch assembly 3, the adjusting buffer block 32 is generally first fitted to the output shaft 220, and then installed together with the actuator 200 within the base frame 100. Therefore, it is generally inconvenient to provide a positioning structure for the adjusting buffer block 32 at the corresponding position of the base frame 100, which leads to the unstable structure of the adjusting buffer block 32 when it is cooperated with the clutch block 331 on the base frame 100 through the clutch groove 321, which in turn can easily affect the normal use of the clutch structure. Therefore, by matching the positioning sleeve 333 on the base frame 100 with the through hole 320 of the adjusting buffer block 32, the adjusting buffer block 32 can be supported while effectively reducing or avoiding the jumping of the adjusting buffer block 32 when it rotates in the circumferential direction.

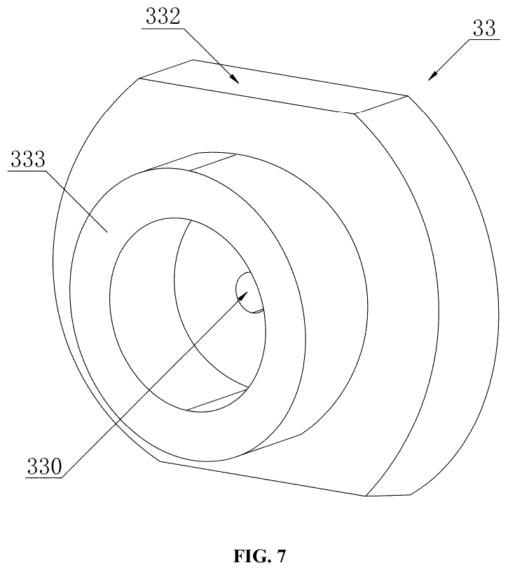

In this embodiment, as shown in FIG. 5 and FIG. 6, the adjusting buffer block 32 is not provided with a clutch groove 321, but an extension 322 is set on the end face of the adjusting buffer block 32. The through hole 320 of the adjusting buffer block 32 passes through the extension 322, and the guiding block 3220 is set on the side wall of the corresponding through hole 320 of the extension 322. Therefore, when the adjusting buffer block 32 is matched with the positioning sleeve 333 through the through hole 320, it can avoid interference between the guiding block 3220 and the positioning sleeve 333.

In this embodiment, there are multiple ways to set the clutch block 331, including but not limited to the following two methods.

Setting method one: The clutch block 331 and the base frame 100 are integrally formed.

Setting method two: Fabricate the clutch block 331 separately, and fix the clutch block 331 at the corresponding position of the base frame 100.

It can be understood that due to the relatively complex structure of the clutch block 331, if it is directly integrated with the base frame 100, it will lead to the complexity of the molding process of the base frame 100, which in turn will lead to an increase in production efficiency and production costs. Therefore, in this embodiment, the preferred setting method for the clutch block 331 is to use the above setting method two.

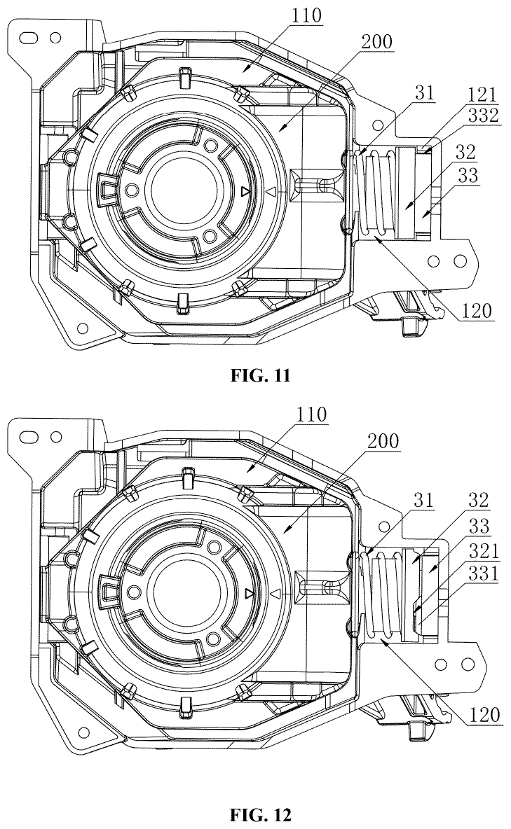

Specifically, as shown in FIG. 2, FIG. 8, FIG. 9, FIG. 11, FIG. 12, and FIG. 14, the clutch assembly 3 further comprises a base frame buffer block 33. The base frame buffer block 33 can be detachably installed at the corresponding position of the base frame 100 by fasteners. The positioning sleeve 333 is arranged in the middle of one end face of the base frame buffer block 33, and the clutch block 331 is located on the side of the same end face of the positioning sleeve 333. Therefore, during the installation of the clutch assembly 3, the base frame buffer block 33 can be supported and matched with the adjusting buffer block 32 through the positioning sleeve 333, and under the action of the spring 31, the adjusting buffer block 32 can be engaged with the base frame buffer block 33 that is provided with the clutch block 331 by setting an end face with a clutch groove 321, thus forming the required clutch structure.

One embodiment of the present disclosure, as shown in FIG. 10 to FIG. 14, includes a base frame 100 with interconnected first installation area 110 and second installation area 120. The actuator 200 is installed in the first installation area 110 and its output shaft 220 extends to the second installation area 120. Clutch assembly 3 is installed in the second installation area 120, and base frame buffer block 33 can be matched with the second installation area 120 through a positioning structure.

In this embodiment, the actuator 200 can form an actuator buffer assembly through assembly with the base frame 100 via the clutch assembly 3. There are multiple specific installation methods for the actuator buffer assembly, in general, the actuator buffer assembly mainly includes the following two installation methods.

Installation method 1: base frame 100 is closed at the end of the second installation area 120 away from the first installation area 110; the installation process of clutch assembly 3 on the base frame 100 is as follows: first, install the clutch assembly 3 on the output shaft 220 of the actuator 200, and then install the actuator 200 together with the clutch assembly 3 in the corresponding first installation area 110 and the second installation area 120 of the base frame 100.

It should be noted that when the actuator buffer assembly is installed in the above manner, it can ensure that the spring 31 has better consistency of damping force, and thus the spring 31 is not easy to deviate or loosen during use; but the overall coaxiality of the clutch assembly 3 is slightly worse, and the installation of the entire assembly is not convenient.

Specifically, as shown in FIG. 6, FIG. 7, FIG. 10, FIG. 11, and FIG. 12, when assembling the clutch assembly 3, first install the spring 31 on the output shaft 220. Then, slide the adjusting buffer block 32 onto the output shaft 220, aligning the guide groove 221 with the guide block 3220, and finally, insert base frame buffer block 33 into the through hole 320 of the adjusting buffer block 32 via the positioning sleeve 333.

The middle of base frame buffer block 33 is provided with a second installation hole 330, and the side wall in the middle of the second installation area 120 of the base frame 100 away from the first installation area 110 is provided with a first installation hole 124. After the clutch assembly 3 is assembled, the actuator 200, which is installed with the clutch assembly 3, is first installed in the base frame 100, wherein the actuator 200 is located in the first installation area 110, and the clutch assembly 3 is all located in the second installation area 120. Then, the actuator 200 is connected by fastening means passing through the first installation hole 124 on the outer side of the second installation area 120 and the second installation hole 330 in the middle of base frame buffer block 33.

For the installation method one, as shown in FIG. 7, FIG. 8, FIG. 10 and FIG. 11, the positioning structure includes at least one horizontal limiting surface 332 set on the side of the base frame buffer block 33, and at least one horizontal positioning surface set on the side of the second installation area 120; base frame buffer block 33 can be fitted with the positioning surface through the limiting surface 332 to ensure the structural stability of base frame buffer block 33.

It can be understood that the connection accuracy of the fasteners is generally low, so the fasteners only need to ensure the connection between base frame buffer block 33 and the base frame 100 in the axial direction. The positioning accuracy of base frame buffer block 33 can be effectively improved by the fitting of the positioning surface and the limit surface 332 in the circumferential direction, which can further improve the structural stability of the clutch assembly 3 during operation. The specific number of limiting surface 332 and positioning surfaces can be selected by those skilled in the art according to actual needs. For example, as shown in FIG. 6 and FIG. 9, the number of limiting surface 332 and positioning surface are both two, and the two limiting surface 332 and two positioning surfaces are symmetrically arranged.

Specifically, as shown in FIG. 7, FIG. 8 and FIG. 10, base frame buffer block 33 is a disc-shaped structure. Symmetrical horizontal planes parallel to the axis can be processed on the side of base frame buffer block 33 through processing such as washing and grinding, and the two horizontal planes are the limiting surface 332. During the injection molding of the base frame 100, positioning block 121 can be formed on both side walls symmetrically in the second installation area 120. Both end faces of the positioning block 121 are horizontal surfaces, forming the required positioning surface.

Installation method 2: Install the installation sleeve 122 in the second installation area 120 of the base frame 100 away from the end of the first installation area 110, and the installation sleeve 122 is connected to the second installation area 120. The installation process of the clutch assembly 3 on the base frame 100 is as follows: first, install the actuator 200 on the base frame 100, and then install the clutch assembly 3 along the installation sleeve 122 on the output shaft 220.

It should be noted that when the actuator buffer assembly is installed using the above installation method 2, it can ensure that the clutch assembly 3 is overall coaxial and the installation of the entire assembly is also relatively convenient. However, the damping consistency of spring 31 is slightly poor. Both of the above installation methods can meet the daily practical use of the vehicle, and those skilled in the art can choose a suitable installation method base on the focus of actual use.

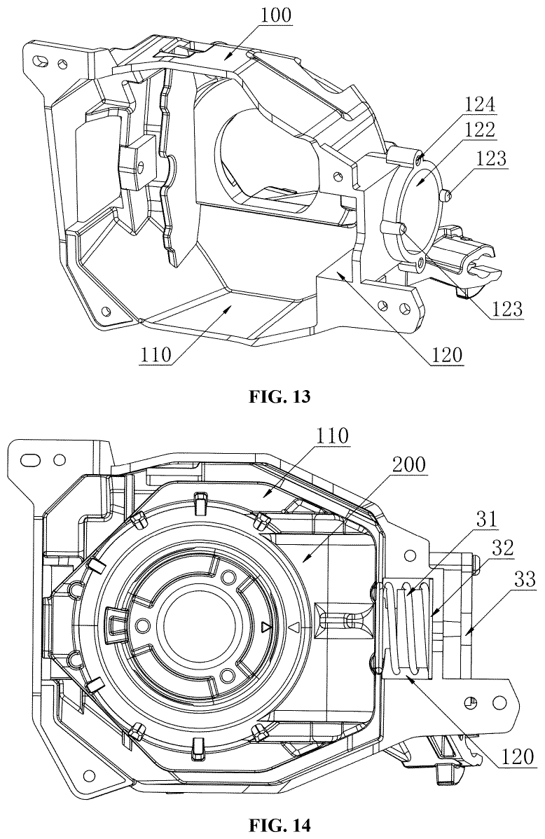

Specifically, as shown in FIG. 9, FIG. 13, and FIG. 14, when assembling the actuator 200, the actuator 200 can be rotatably installed in the first installation area 110, and the output shaft 220 of the actuator 200 can extend to the second installation area 120, and the axis of the output shaft 220 is aligned with the axis of the installation sleeve 122.

A pair of symmetric second installation hole 330 are arranged on the outer side of the base frame buffer block 33, and a pair of first installation hole 124 are symmetrically arranged on the outer side of the installation sleeve 122. After the actuator 200 is installed, the spring 31 can be first fitted onto the output shaft 220 of the actuator 200 along the opening of the installation sleeve 122; then, the adjusting buffer block 32 is also slidably installed along the opening of the installation sleeve 122 onto the output shaft 220, and the guide groove 221 is aligned and matched with the guide block 3220; finally, the base frame buffer block 33 is inserted into the through hole 320 of the adjusting buffer block 32 by means of the positioning sleeve 333, and the second installation hole 330 of the base frame buffer block 33 is aligned with the first installation hole 124 of the installation sleeve 122, and then a pair of fasteners are respectively passed through the corresponding second installation hole 330 and the first installation hole 124 for fastening connection.

It can be understood that the base frame buffer block 33 is generally a disc structure. In order to facilitate the setting of the second installation hole 330, a cover plate 334 can be set on the end face of the base frame buffer block 33 where no clutch block 331 is set. The size of the cover plate 334 is larger than the opening size of the installation sleeve 122, so the second installation hole 330 can be set on the side of the cover plate 334 to ensure that the cover plate 334 can be secured to the installation sleeve 122 by fasteners in the axial direction, thereby ensuring the axial stability of the base frame buffer block 33.

For the second installation method, as shown in FIG. 9 and FIG. 13, the positioning structure includes a pair of positioning column 123, which are spaced apart from the outer side of the installation sleeve 122, and a pair of positioning hole 3340, which are spaced apart from the side of the base frame buffer block 33. Therefore, the base frame buffer block 33 can be positioned and coordinated with the positioning column 123 through the positioning hole 3340, ensuring the stability of the structural circle of the base frame buffer block 33.

Another aspect of the present disclosure provides a rearview mirror, wherein a preferred embodiment includes an actuator 200 and a base frame 100, and the actuator 200 and the base frame 100 can be matched with the actuator buffer structure described above.

Another aspect of the present disclosure provides a vehicle, wherein a preferred embodiment comprises the above rearview mirror.

The above describes the basic principle, main characteristics and advantages of the present disclosure. Those skilled in the art should understand that the present disclosure is not limited by the foregoing embodiments. The foregoing embodiments and the description in the specification only illustrate the principles of the present disclosure. The present disclosure may have various changes and improvements without departing from the spirit and scope of the present disclosure, and these changes and improvements all fall within the claimed scope of the present disclosure. The claimed scope of the present disclosure is defined by the appended claims and their equivalents.

What is claimed is:

1. An actuator buffer, comprising:
a base frame for installing a rear-view element;
an actuator fixedly installed and rotatably connected to the base frame; and
a clutch assembly for connecting an output shaft of the actuator to the base frame,
wherein the actuator is configured for driving the output shaft to rotate the base frame together with the rear-view element around an axis via the clutch assembly,
wherein the base frame is configured to disengage from the output shaft via the clutch assembly under external force, and
wherein the base frame rotate together with the rear-view element relative to the output shaft via the actuator.

2. The actuator buffer according to claim 1, wherein
the clutch assembly comprises an adjusting buffer block axially slidably installed on the output shaft,
the adjusting buffer block is adapted to be axially elastically connected to the actuator or the base frame, and
cooperation between the adjusting buffer block and the base frame is achieved via the clutch assembly.

3. The actuator buffer structure according to claim 2, wherein
when the actuator is started, the adjusting buffer block remains engaged with the base frame in a circumferential direction under action of elasticity via the clutch assembly, and
when the base frame is driven by external force, the adjusting buffer block disengages from the base frame in the circumferential direction via the clutch assembly.

4. The actuator buffer structure according to claim 2, wherein
the adjusting buffer block cooperates with the output shaft via a connecting hole,
the output shaft has a guide groove along an axial extension, and
a side wall of the connecting hole has a guide block, wherein the guide block and the guide groove slide along an axial direction and are limitedly matched along a circumferential direction.

5. The actuator buffer structure according to claim 2, wherein the adjusting buffer block forms part of the clutch assembly by circumferential frictional engagement with the base frame through an end face.

6. The actuator buffer structure according to claim 5, wherein
when the actuator is started, a driving force of the actuator is less than a friction force between the end face of the adjusting buffer block and the base frame in a circumferential direction, and
when the base frame is driven by external force, a pressing force received by the base frame is greater than the friction force but less than a self-locking force of the output shaft.

7. The actuator buffer structure according to claim 1, wherein
the clutch assembly comprises a clutch groove set on an end face of the adjusting buffer block and a clutch block set on the base frame, and
the clutch groove and the clutch block engage with each other in a circumferential direction.

8. The actuator buffer structure according to claim 7, wherein
when the actuator is started, a driving force of the actuator is less than an engagement force between the clutch groove and the clutch block in a circumferential direction, and
when driving the base frame by external force, a pressing force applied to the base frame is greater than the engagement force and less than a self-locking force of the output shaft.

9. The actuator buffer structure according to claim 7, wherein
the clutch assembly further comprises a base frame buffer block,
the base frame buffer block is detachably installed on the base frame,
the base frame buffer block is adapted to axially slidably cooperate with the connecting hole of the adjusting buffer block via a positioning sleeve, and
the clutch block is disposed on an end face of the base frame buffer block so as to form the clutch assembly between the adjusting buffer block and the base frame buffer block.

10. The actuator buffer structure according to claim 9, wherein
the base frame is provided with interconnected first and second installation areas,
the actuator is installed in the first installation area and its output shaft extends to the second installation area,
the clutch assembly is installed in the second installation area, and
the base frame buffer block is matched with the second installation area through a positioning structure.

11. The actuator buffer structure according to claim 9, wherein
the clutch assembly is configured to be first installed on the output shaft, and then the actuator and the clutch assembly are installed on the base frame, and
the base frame buffer block is connected to a side wall of the second installation area via fasteners.

12. The actuator buffer structure according to claim 9, wherein
the positioning sleeve includes at least one horizontal limiting surface set on a side of the base frame buffer block and at least one horizontal positioning surface set on a side of the second installation area, and
the base frame buffer block is configured to be attached to the positioning sleeve through a limiting surface.

13. The actuator buffer structure according to claim 9, further comprising:
an installation sleeve penetrating through the base frame at an end of the second installation area,
wherein an axis of the output shaft is aligned with an axis of the installation sleeve.

14. The actuator buffer structure according to claim 13, wherein
the actuator is first installed on the base frame and then the clutch assembly is installed along the installation sleeve on the output shaft;
the base frame buffer block is fixed on an exterior of the installation sleeve by a pair of symmetrical fasteners;
the positioning structure comprises a pair of positioning columns spaced apart from an outer side of the installation sleeve and a pair of positioning holes spaced apart from a side of the base frame buffer block; and/or
the base frame buffer block is configured to be positioned and matched with the positioning columns through the positioning holes.

15. A rear-view device, comprising the actuator buffer structure according to claim 1.

16. The rear-view device according to claim 15, wherein the rear-view element comprises a mirror and/or camera.

17. A vehicle comprising the rear-view device according to claim 15.
